(19) United States
(12) Patent Application Publication
(10) Pub. No.: US 2025/0310776 A1
(43) Pub. Date: Oct. 2, 2025

(54) SYSTEMS AND METHODS FOR TRUSTWORTHINESS DETERMINATION

(71) Applicant: InterDigital Patent Holdings, Inc., Wilmington, DE (US)

(72) Inventors: Zhibi Wang, Woodridge, IL (US); Morteza Kheirkhah, London (GB); Alec Brusilovsky, Downingtown, PA (US); Ulises Olvera-Hernandez, Saint-Lazare (CA); Samir Ferdi, Kirkland (CA); Michael Starsinic, Newtown, PA (US)

(73) Assignee: InterDigital Patent Holdings, Inc., Wilmington, DE (US)

(21) Appl. No.: 18/837,291

(22) PCT Filed: Feb. 10, 2023
(86) PCT No.: PCT/US2023/012783

§ 371 Date: Aug. 9, 2024

Related U.S. Application Data
(60) Provisional application No. 63/309,161, filed on Feb. 11, 2022.
(60) Provisional application No. 63/437,173, filed on Jan. 5, 2023.

(51) Int. Cl. H04W 12/60; H04L 41/16; H04W 12/37; H04W 64/00

(52) U.S. Cl. CPC H04W 12/66; H04L 41/16; H04W 12/37; H04W 64/00

(57) ABSTRACT

Described herein are systems, methods and instrumentalities associated with a trustworthiness evaluation framework for determining the trustworthiness of a wireless transmit/receive unit (WTRU) to participate in a network operation such as an artificial intelligence machine learning (AIML) operation. The framework may provide capabilities for monitoring, evaluating, and/or selecting the WTRU to participate in the network operation. The trustworthiness of the WTRU may be evaluated based on data and/or analytics such as the privileges and security state of the WTRU, security policy rules, the behavior history of the WTRU, the attributes and/or reputations of the WTRU, referrals for the WTRU from other entities, etc. A trustworthiness level or score may be determined to indicate the trustworthiness of the WTRU. An access policy may be dynamically formed and/or enforced to reflect the trustworthiness of THE WTRU.

### BACKGROUND

A wireless transmit/receive unit (WTRU) may be selected to participate in one or more network operations such as a distributed artificial intelligence (AI) and/or machine learning (ML) training session. Since a malicious WTRU may launch an attack on such operations, the WTRU's trustworthiness should be evaluated to determine if the WTRU can be selected to participate in these operations (e.g., in addition to authentication and/or authorization of the WTRU).

### SUMMARY

Described herein are systems, methods, and instrumentalities associated with determining the trustworthiness of a device for participating in one or more operations carried out in a wireless communication network. According to embodiments of the present disclosure, a network entity (e.g., one or more core network devices) involved in the trustworthiness determination may include a processor configured to receive a request to evaluate the trustworthiness of a wireless transmit/receive unit (WTRU) for participating in the one or more operations of the wireless communication network, wherein the request may include a set of criteria associated with the evaluation. The processor may be further configured to collect information regarding the WTRU based on the set of criteria indicated by the request, determine, from the collected information, the trustworthiness of the WTRU for participating in the one or more operations of the wireless communication network, and send an indication of the trustworthiness of the WTRU, for example, to another network entity or an application server associated with the one or more operations.

In some embodiments, the one or more operations of the wireless communication network described herein may include an artificial intelligence machine learning (AIML) operation such as an operation associated with training an AIML model. In some embodiments, the set of criteria included in the trustworthiness evaluation request may indicate at least one of a geographical location, a network slice, a data network name, an application associated with the one or more operations of the wireless communication network, a time period associated with the evaluation, an AIML model associated with the one or more operations of the wireless communication network, a traffic characteristic of the one or more operations of the wireless communication network (e.g., a latency threshold, an error rate, and/or a quality of service (QoS) requirement), or an application server associated with the one or more operations of the wireless communication network.

In some embodiments, the information collected by the network entity may indicate at least one of a privilege or a security state of the WTRU, or a behavior history of the WTRU. In some embodiments, the information collected by the network entity may indicate at least one of an attribute or reputation of the WTRU, a referral for the WTRU to participate in the one or more operations of the wireless communication network, or a security policy of the wireless communication network. In some embodiments, the indication of the trustworthiness provided by the network entity may include a trustworthiness level of the WTRU, an identifier of the WTRU, or a time period during which the indication may be deemed valid. In some embodiments, the request to evaluate the trustworthiness of the WTRU may be received from another network entity or an application server, and wherein the indication of the trustworthiness of the WTRU is sent to the other network entity or the application server. In some embodiments, the network entity may be further configured to generate a token for the WTRU that may indicate the trustworthiness of the WTRU for participating in the one or more operations of the wireless communication network.

In some embodiments, a wireless transmit/receive unit (WTRU) may be configured to collect information regarding at least one of a security state of the WTRU, a behavior history of the WTRU, or an attribute of the WTRU, send the collected information to a server device associated with a wireless communication network, and receive an indication of a trustworthiness of the WTRU for participating in one or more operations of the wireless communication network. The trustworthiness of the WTRU may be determined based at least on the information collected and sent by the WTRU, and the WTRU may participate in the one or more operations of the wireless communication network if the WTRU is indicated as being trustworthy.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of conducting a trustworthiness evaluation based on data and/or analytics.

FIG. 3 is a diagram illustrating an example of selecting a WTRU for AIML operations based on the trustworthiness of the WTRU.

FIG. 4 is a diagram illustrating example operations, messages, and/or call flows that may be associated with performing a trustworthiness evaluation in a wireless communication system.

FIG. 5 is another diagram illustrating example operations, messages, and/or call flows that may be associated with performing a trustworthiness evaluation in a wireless communication system.

FIG. 6 is another diagram illustrating example operations, messages, and/or call flows that may be associated with performing a trustworthiness evaluation in a wireless communication system.

FIG. 7 is a diagram illustrating an example of PDU session establishment based on the trustworthiness of a WTRU.

FIG. 8 is a diagram illustrating another example of PDU session establishment based on the trustworthiness of a WTRU.

### DETAILED DESCRIPITION

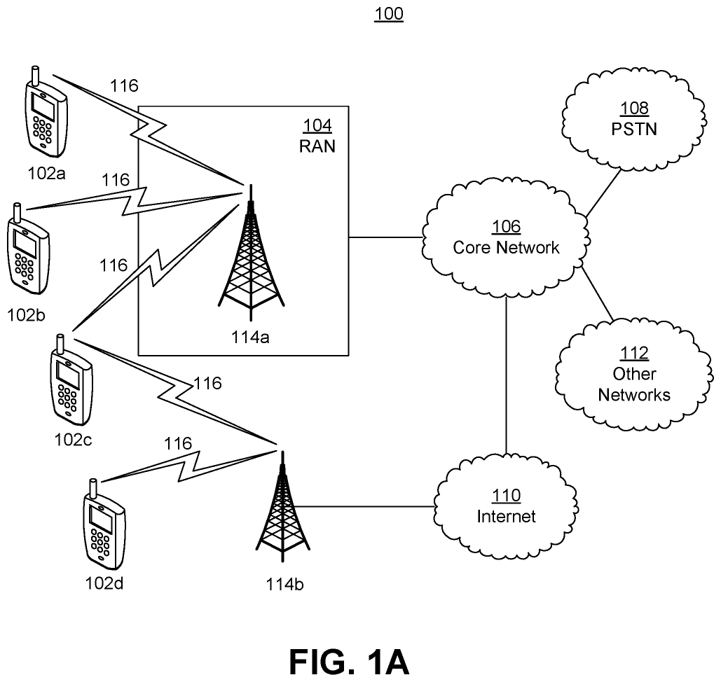

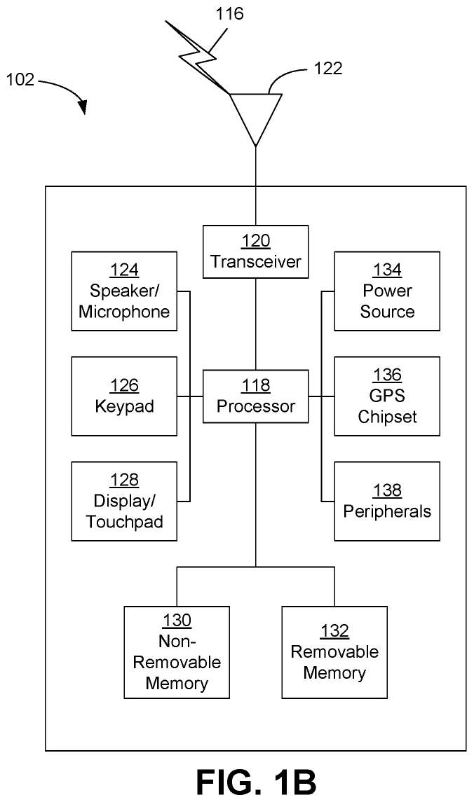

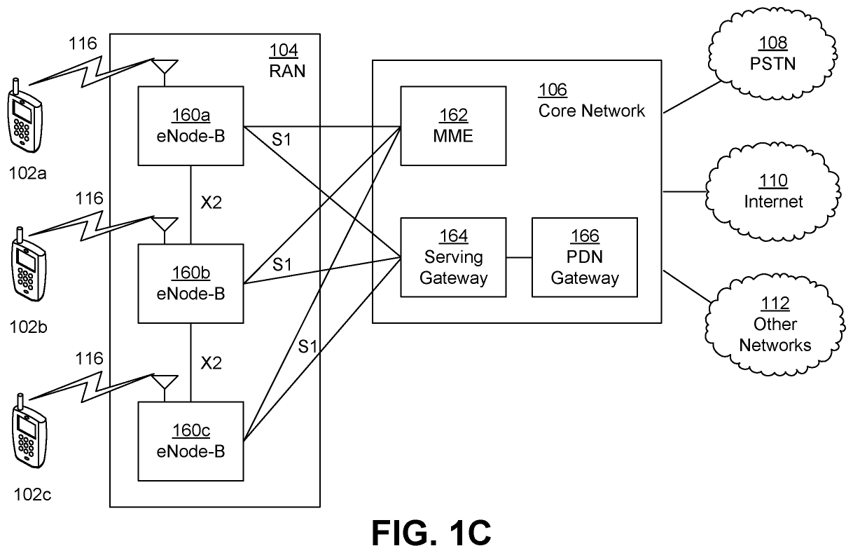

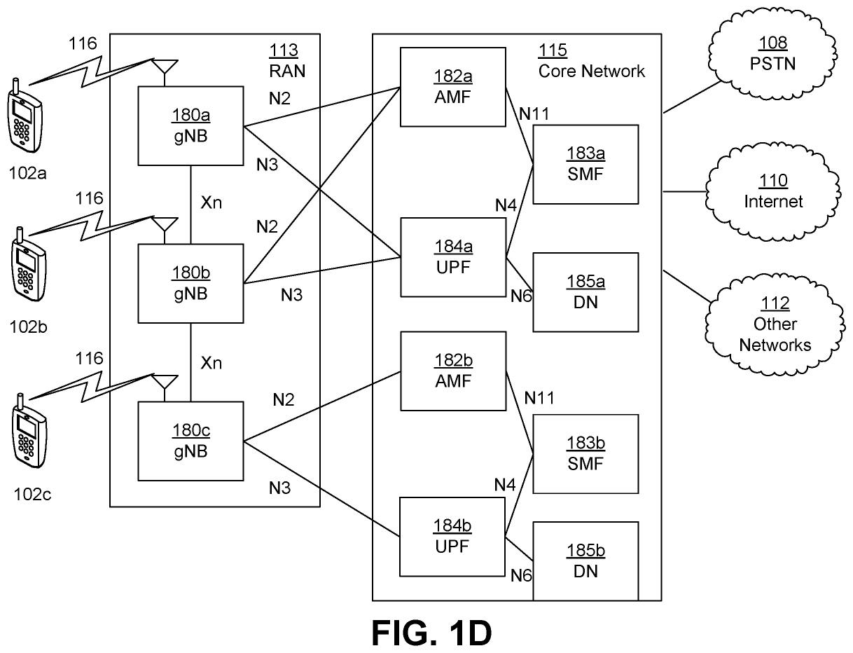

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

With some operations in a wireless communication system (e.g., training an artificial intelligence machine learning (AIML) model such as a Federated Learning (FL) model), an application server (AS) or a network entity (e.g., one or more network nodes or devices) may select a set of devices (e.g., WTRUs) to participate in the operations (e.g., in a distributed training session). Techniques for making the selection based on the trustworthiness of the devices may be described herein using AIML training as an example, but those skilled in the art will appreciate that the techniques may not be limited to AIML operations and may be applied to other types of operations as well. Further, a network entity may be used in the examples provided herein and those skilled in the art will appreciate that such a network entity may include one or multiple network devices and network nodes organized to perform a set of related logical functions.

An AIML training session may include one or more training cycles and during a (e.g., each) training cycle, an AS may select a set of WTRUs to participate in the training of a model (e.g., a global model). In some examples, the AS may (e.g., repeatedly) re-select a group of WTRUs that have performed well in the training. In other examples, the AS may shuffle the participating WTRUs (e.g., more diverse participants in a training session may lead to more diverse environments and/or datasets to be used in the training, which may result in more accurate results). An application function (AF) (e.g., which may reside on the AS) may be configured to manage the training sessions on behalf of the AS and may engage in the WTRU selection. The AF may be located within a trusted domain or an untrusted domain of an operator's network. In the latter case, the AF may interact with one or more core (e.g., 5G core or 5GC) network components or functions via a network exposure function (NEF).

A malicious WTRU may have opportunities and capabilities to launch an attack on the core network, the AS/AF, or the AIML operation if such a WTRU is selected to participate in an AIML operation such as an FL operation. A WTRU may be deemed trustworthy if it can be trusted to perform certain functionalities without betrayal or malicious intent. For example, a WTRU may be deemed trustworthy if it can be trusted not to reveal information sent by an AIML AS, not to launch AIML attacks on an AIML model (e.g., an intermediate model that may be merged into a global model), etc. As such, the trustworthiness of the WTRU may be evaluated (e.g., in addition to authentication and/or authorization of the WTRU). For example, before the WTRU (e.g., a network device or element) is authorized to access a resource (e.g., a network resource) or perform an action on the resource (e.g., such as accessing and performing federated trainings using an intermediate model from an AIML process), the trustworthiness of the WTRU may be evaluated before it is granted access to the resource.

The trustworthiness of the WTRU may be evaluated (e.g., before selecting the WTRU for AIML or FL training operations) to minimize potential security risks to the AIML operation (e.g., to the FL process or session). A trustworthiness evaluation framework may be established to monitor, evaluate, and/or select WTRUs or other devices or components (e.g., including client applications that may support the AIML operations in a WTRU) for machine learning and/or artificial intelligence related operations (e.g., such as FL operations).

One or more of the following trustworthiness and/or security related issues may be considered and/or addressed to support AIML operations over a wireless network such as a third generation partnership project (3GPP) network: whether and what data, analytics, and/or predictions may be used by a WTRU and/or a core network (CN) to enable the AIML operations in a trustworthy WTRU that may support such operations; whether and how to evaluate (e.g., dynamically) a WTRU's trustworthiness (e.g., trustworthiness level or score) within a 3GPP system; and/or whether and how to communicate the trustworthiness (e.g., trustworthiness score) of a WTRU to an AS to determine whether the WTRU may be considered for the AIML operations (e.g., being a part of a next round of FL operations).

The trustworthiness of a candidate participant such as a WTRU for AIML operations may be evaluated (e.g., dynamically) based on data and/or analytics collected and/or provided by a network function and/or a WTRU. These data and/or analytics may be obtained from a network function (e.g., including an agent that may be integrated into a network function or device) that may be configured to enable AIML operation traffic (e.g., such as FL application traffic) in a wireless communication network. These data and/or analytics may be collected, determined, and/or provided by a WTRU (e.g., on a periodic basis). These data and/or analytics may be used as filters for selecting trustworthy WTRUs and may include, for example, logs (e.g., activity logs), device privileges and/or security states (e.g., whether the WTRU has been validated by a system and/or data network), security policies, network states (e.g., whether a network slice or a data network includes a WTRU or a group of WTRUs that has been validated by the network slice or data network), behavior histories, device attributes (e.g., capabilities of the WTRU), device reputations (e.g., with respect to performance in previous AIML operations), referrals from other entities (e.g., an application server generating application AIML operation traffic, an application such as a video application that may benefit from the application AIML operation, etc.), software patches, device remote attestations (e.g., a confirmation of the WTRU's security status), etc. These data and/or analytics may be used to monitor and evaluate the trustworthiness of a potential participant (e.g., a WTRU) in the AIML operations (e.g., such as an FL training or inference session) to avoid potential threats to the AI/ML operations.

Network data analytics may be enhanced to enable the generation of analytics for determining the trustworthiness of a WTRU or a set of WTRUs that may have access to specific network resources (e.g., within a specific network slice, a specific data network name (DNN), etc.). A network data analytics framework may include one or more of the following. The network data analytics framework may include one or more analytics IDs for identifying data elements included in the analytics. The network data analytics framework may include a trustworthiness level (or score), which may indicate low trustworthiness, medium trustworthiness, high trustworthiness, etc. The trustworthiness level may be represented by a binary value indicating whether a device is trusted or not trusted. The trustworthiness level may be indicated by a scalar value within a range (e.g., 0 to 1000, with 0 representing the lowest level of trustworthiness and 1000 representing the highest level of trustworthiness). The trustworthiness level may include a security risk level (e.g., from 0 to 10, where 10 may correspond to a high risk and 0 may correspond to no risk).

The network data analytics framework may include or specify one or more analytics filters that may restrict the scope or range of a trustworthiness evaluation. For example, the analytics filters may include an area of interest (AoI) that may indicate a geographical location associated with a trustworthiness evaluation, a cell associated with the trustworthiness evaluation, a tracking area (TA) associated with a trustworthiness evaluation, and/or a registration area (RA) associated with the trustworthiness evaluation (e.g., where the analytics may be generated). The analytics filters may include network slice information such as single network slice selection assistance information (S-NSSAI) associated with a network slice that may provide the resources used by a WTRU to generate application AIML operation traffic. The analytics filters may include a DNN that may indicate the data network accessed by a WTRU when the trustworthiness evaluation is taking place. The analytics filters may include one or more ML models (e.g., valid ML models) associated with the trustworthiness evaluation. The analytics filters may include traffic characteristics, such as whether certain traffic may correspond to an application AIML operation. The analytics filters may include a valid application ID of an application that may be running while the trustworthiness evaluation is conducted (e.g., during an evaluation window/period). The analytics filters may include a time window for when the trustworthiness evaluation may take place. The analytics filters may include the application server addresses of one or more AIML application servers (e.g., in addition to the AIML application server requesting the trustworthiness evaluation). These application servers may provide reputation referrals and/or risk reports about WTRUs (e.g., WTRUs known to the application servers) that may have exhibited unreliable or reliable behaviors, the security risks associated with those WTRUs, and/or the confidence levels of those WTRUs. The analytics filters may include a target for analytics reporting, which may be a WTRU (e.g., identified by a subscription permanent identifier (SUPI) or a group of WTRUs (e.g., identified by an internal group ID or a list of WTRUs). The analytics filters may include a traffic usage threshold that may be used to determine an acceptable level of traffic generated by a WTRU or a group of WTRUs when running an application with certain traffic characteristics.

A network entity or device such as one hosting a network data analytics function (NWDAF) may use the services of other network functions (NFs) or devices to collect information (e.g., input data) that may enable the network entity or device to produce the trustworthiness level analytics described herein, e.g., for a WTRU or a group of WTRUs. For example, the network device may collect information from a unified data management (UDM) function or a unified data repository (UDR) regarding WTRU behaviors (e.g., as indicated by one or more WTRU behavioral parameters) and the collected information may enable the network entity or device to construct a behavioral history of the relevant WTRU(s). The UDM may store information associated with referrals that may be provided by an AIML application function (AIML AF) configured to report abnormal WTRU behaviors, abnormal communication types (e.g., communications going only in one direction), traffics happening at an abnormal time of the day, etc. As another example, the network entity or device may collect information from a policy control function (PCF) to determine how services may trigger policies from the PCF, to determine possible abnormal behaviors for certain applications, etc. As yet another example, the network entity or device may collect traffic usage information from an operation, administration and maintenance (OAM) function or from a user plane function (UPF) that may be configured to handle traffics associated with a particular application.

Table 1 below illustrates example information (e.g., input data) that may be collected and/or used by a network entity or device (e.g., NWDAF) for trustworthiness evaluation.

TABLE 1
Examples of Input Data for Trustworthiness Evaluation

| Information | Example Source | Description |
|---|---|---|
| WTRU ID | AMF, SMF, AF | An identifier for the WTRU such |
| | | as a generic public subscription |
| | | identifier (GPSI) |
| Group ID | AMF, SMF, AF | An identifier of a WTRU group, |
| | | which may be provided by the |
| | | AF |
| AoI | AMF, SMF, | An area of interest, e.g., a |
| | | geographical location, cell, TA, |
| | | or RA, as described herein |
| S-NSSAI | SMF | Information to identify resources |
| | | in a network slice |
| DNN | SMF | A DNN where PDU sessions |
| | | supporting AIML traffic may be |
| | | located |
| Application ID(s) | SMF, AF | Application ID(s) associated with |
| | | application AIML traffic and/or |
| | | applications that may use the |
| | | traffic |
| Machine Learning Models | AF | Machine learning models |
| | | approved to generate traffic such |
| | | as those on a specific network |
| | | slice |
| AIML Server Address(es) | SMF, AF | AIML server addresses (e.g., IP |
| | | addresses or fully qualified |
| | | domain names (FQDN)) of AIML |
| | | servers that may provide |
| | | historical data associated with |
| | | WTRU behaviors |
| Validity Time Window | AF | A time window or time period |
| | | during which data collection may |
| | | be performed |
| Traffic Usage Threshold | OAM, UPF | Allowed traffic usage that may |
| | | be associated with application |
| | | AIML operations |
| Security State | AMF, UDM, Authentication | An indication of whether a |
| | Server Function (AUSF) | WTRU or a group of WTRUs |
| | | have been validated by a system |
| | | and/or data network |
| Security Policy Rules | PCF, UDM, AUSF | Operator rules that may indicate |
| | | how to interpret different |
| | | trustworthiness levels when |
| | | determining access to network |
| | | resources to support AIML traffic |
| | | on a network |

A network entity or device such as one hosting an NWDAF may provide trustworthiness evaluation results (e.g., output analytics) to another device (e.g., such as an AF). The results may indicate the trustworthiness level(s) of a WTRU or a group of WTRUs, for example, as shown in Table 2 below. Note that the trustworthiness level(s) may be associated with a server, ML model, a validity time, etc.

TABLE 2
Examples of trustworthiness related output analytics

| Information | Description |
|---|---|
| WTRU group ID or WTRU ID | Identifier(s) of a WTRU or a WTRU group for |
| | which a trustworthiness level is provided (e.g., by |
| | the NWDAF) |
| Trustworthiness Level | AIML server(s) with which normal or abnormal |
| >AI/ML server ID(s) | behaviors of the WTRU(s) have been identified |
| >Machine Learning Model(s) | Machine learning model(s) where normal or |
| | abnormal behaviors of the WTRU(s) have been |
| | identified |
| >Confidence Level | Confidence level (e.g., in addition to an overall |
| | trustworthiness) associated with a particular |
| | machine learning model such as a model identified |
| | by the field above |
| >Privilege Factor | Indication (e.g., provided by an NWDAF) of |
| | whether the WTRU(s) are able to access (e.g., |
| | consistently) AIML server resources |
| >Analytics Output Validity Time | Time window during which the trustworthiness |
| | related output analytics are valid |

A trustworthiness framework (e.g., one or more devices in the framework) may be configured to perform one or more of the following tasks. The framework may monitor, evaluate, and/or select devices or applications (e.g., client applications supporting AIML operations in a WTRU) based on the trustworthiness of those devices or applications in carrying out AIML operations such as FL operations. In examples, an agent associated with the trustworthiness evaluation described herein may be created, which may include or be a part of an application, a service layer, a network function, a network device or entity, a service enabler, and/or an application that may be hosted in a WTRU, a base station, a core network function, or a core network node. The agent may be responsible for enforcing the trustworthiness functionalities of a (e.g., every) participant of an AIML operation (e.g., including training and/or inference). The agent may be built into the participant of the AIML operation. The agent may be built into a portal or gateway (e.g., for resource-limited devices such as lightweight IoT devices). The agent may collect (e.g., dynamically) data from the participant for real-time training and/or evaluation of the trustworthiness of a subject (e.g., an application in a WTRU configured to execute a task as a part of an AIML operation). The agent may work alone (e.g., autonomously) or with other agents to perform the functions described herein.

A trustworthiness framework (e.g., one or more devices in the framework) may evaluate the trustworthiness of a device (e.g., dynamically) based on a trustworthiness level or score. The trustworthiness evaluation may be used to determine whether to authorize a resource access request and the evaluation may be performed based on device privileges and/or security states, security policy rules, network states, device behavior history, device attributes, device reputations, referrals from other entities, etc. that may collected and/or determined by a core network entity (e.g., a TEF) and/or the device itself (e.g., a WTRU). The trustworthiness level or score may reflect the confidence level for a device to access resources (e.g., such as an AIML intermediate model) in supporting an AIML operation. A network entity or device such as one hosting an NWDAF may derive the trustworthiness level(s) of a WTRU or multiple WTRUs that may participate in an application AIML operation and use specific network resources (e.g., a specific S-NSSAI and DNN) for the AIML operation.

A trustworthiness framework (e.g., one or more devices in the framework) may perform a trust decision function to enforce one or more resource access policies that may guide the selection of a WTRU for AIML operations (e.g., FL operations). The one or more resource access policies may reflect the trustworthiness of a device or entity according to its trustworthiness score and/or whether the device or entity may be trusted to perform certain functionalities within an AIML operation. The one or more resource access policies may be formed (e.g., dynamically formed) as a function of the resource(s) accessed, the AIML operation, a trustworthiness score, and/or a least privilege principle (e.g., a security principle under which users and/or programs may only have the necessary privileges for completing their tasks). The one or more resource access policies may be generated and/or adjusted by an AS, AF, or a core network entity or device.

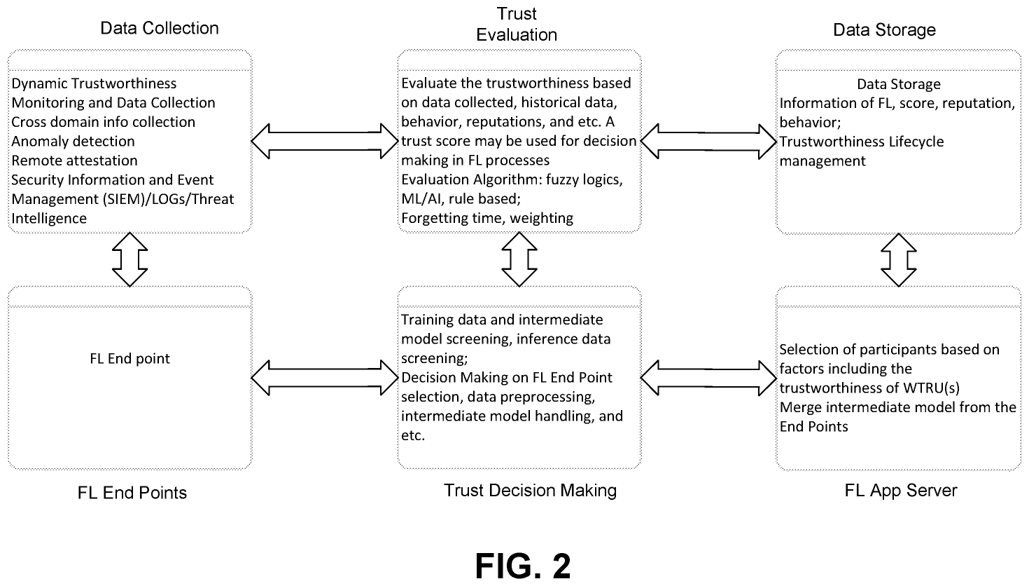

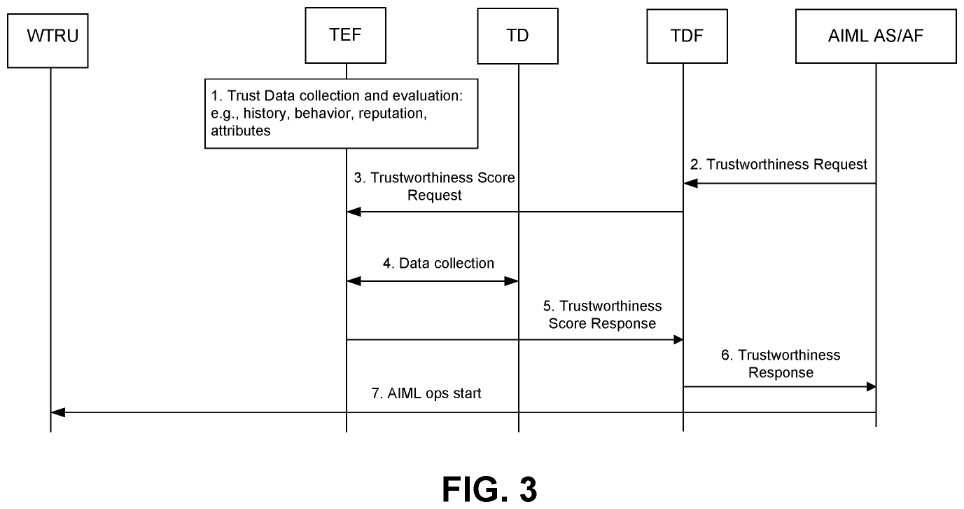

FIG. 2 illustrates example operations that may be associated with a trustworthiness evaluation based on data and/or analytics. FIG. 3 illustrates an example of selecting a WTRU for AIML operations based on the trustworthiness of the WTRU. As shown in FIG. 3, a trust evaluation function (TEF) may, at 1, obtain trust data that may be used to evaluate the trustworthiness of a WTRU as a candidate for AIML operations (e.g., FL operations). The trust data may include a history of the device as an AIML client, device behaviors and/or feedback as an AIML client, referrals from other AIML operation participants, device reputation (e.g., when collaborating with other devices and/or AIML application servers), device security posture such as security software patches, trusted environment capabilities, logs, device privileges, network security states, security policy rules, device attributes, and/or the like. The trust data may be collected from various sources include the candidate WTRU(s) and the data collection may last as long as needed (e.g., until all desired data are collected) or in short bursts (e.g., periodically) dependent on network conditions.

In examples, an AIML operation and/or AIML AS may select a set of candidates (e.g., such as one or more WTRUs) based on the type of AIML operations to be executed. For instance, the AIML operation and/or AS may, at 2, send a request to a trust decision function (TDF) for additional screening of the candidates (e.g., based on each candidate's trustworthiness). The request may include a list of candidates (e.g., a list of WTRUs) to be screened. The request may include a set of criteria that the TDF may use to create a candidate list. For example, the criteria included in the request may indicate that the AIML AS desires a list of 100 WTRUs in a certain geographical area. The TDF may query a network device or function such as a unified data management (UDM) function and/or a unified data repository (UDR) to obtain a list of WTRUs that match the indicated criteria.

In examples, the selection of one or more WTRUs for AIML operations may include selecting a candidate set of WTRUs based on criteria such as locations, user consents, WTRU capabilities, etc. and further selecting one or more WTRUs from the candidate set based on the trustworthiness of the WTRUs. In examples where the selection of one or more WTRUs for AIML operations may be performed based on the trustworthiness of the WTRUs, a candidate set of WTRUs (e.g., a candidate set not pre-filtered by other criteria such as locations, user contents, and/or capabilities) may be sent to a group selection function, of which the TEF may be a sub-function.

At 3, the TDF may (e.g., in response to receiving the trustworthiness request at 2) request the TEF to perform a trustworthiness evaluation of one or more candidates (e.g., each candidate) in a candidate set. The TEF may evaluate the trustworthiness of the candidates, for example, using data obtained from a trust database (TD). The TEF may determine respective trustworthiness levels or scores of the candidates and provide the trustworthiness levels or scores to the TDF (e.g., for each candidate in the set provided by the AIML AS). The TEF may perform the trust evaluations based on data collected at 1. The TEF may perform the trust evaluation using one or more suitable AIML techniques including, for example, clustering, neural networks, fuzzy logics, rule-based AI (e.g., an AI model based on a set of predetermined rules that may result in pre-defined outcome), etc. The TEF may use a combination of these techniques to produce the trustworthiness levels or scores (e.g., which may provide more flexibility to the evaluation).

The TEF may apply additional evaluation criteria (e.g., such as a candidate's capability to accurately and reliably perform AIML operations in addition to the candidate's trustworthiness) to the candidate selection. The TEF may consider a candidate device (e.g., a WTRU) to be suitable for AIML operations if the candidate device may provide data that accurately represent a user's experience. In examples, the selection or evaluation criteria may include trustworthiness and reliability criteria (e.g., the reliability criterial may relate to whether a device may accurately and/or reliably perform one or more AIML operations).

The TEF may, at 5, send the determined trustworthiness level or score for each candidate (e.g., for each WTRU in the candidate set) to the TDF for further screening. The TDF may perform the screening based on resources access policies and may provide a screened set of candidates to be used for the relevant AIML operations. The TEF may also send the trustworthiness level or score for each candidate (e.g., for each WTRU in the candidate set) to the AIML AS (e.g., directly to the AIML AS) to make a final decision.

At 6, the AIML AS may receive a trustworthiness response, for example, from the TDF and/or the TEF. If the AIML AS agrees with the decision or evaluation from the TDF and/or the TEF, the AIML AS may carry out the relevant AIML operations (e.g., starting a round of FL operations by sending an intermediate model to the selected WTRUs). If the AIML AS receives trustworthiness levels or scores at 6 (e.g., from the TEF), the AI/ML AS may make a decision about the candidate WTRUs based on the received levels or scores.

One or more entities associated with the trustworthiness and/or security functionalities described herein may be mapped to (e.g., performed by) core network (e.g., 5GC) functions. In examples, the TEF may be mapped to a data collection coordination function (DCCF), the TD may be mapped to a 5G analytics logical function (AnLF), and the TDF may be mapped to a policy control function (PCF) and/or a session management function (SMF). The SMF may play a role similar to what the SMF plays during extensible authentication protocol (EAP) authentication (e.g., to support secondary authentication of external data networks). In examples, the TEF may be mapped to a DCCF, the TD may be mapped to a 5G network data analytics function (NWDAF), and the TDF may be mapped to a network exposure function (NEF).

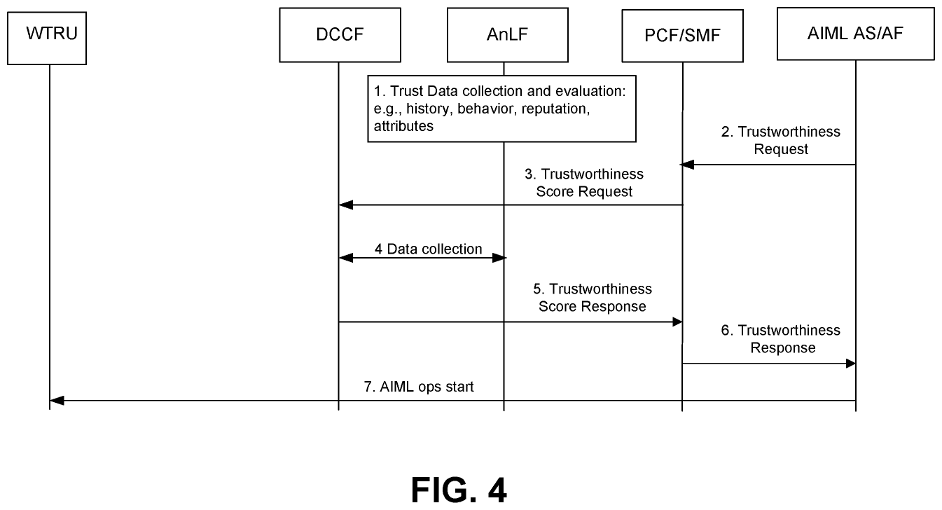

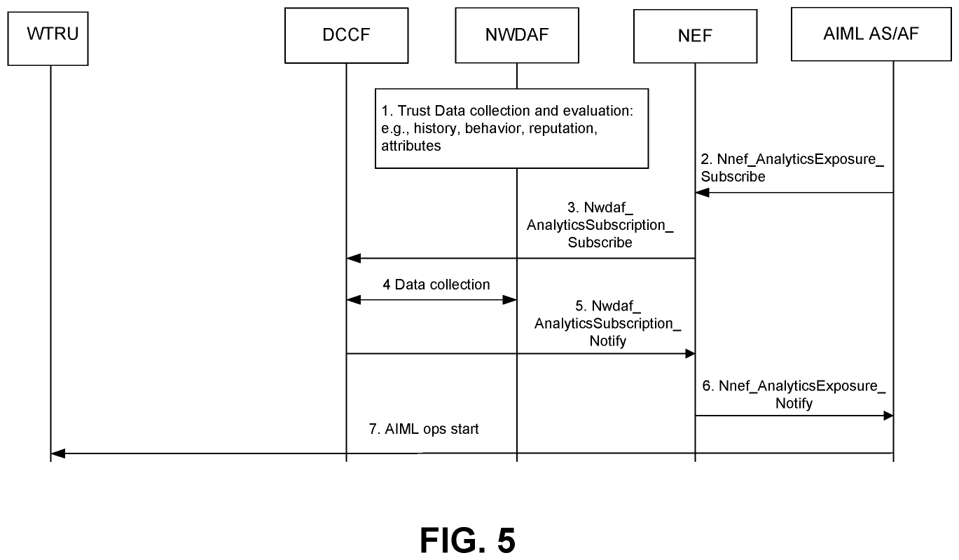

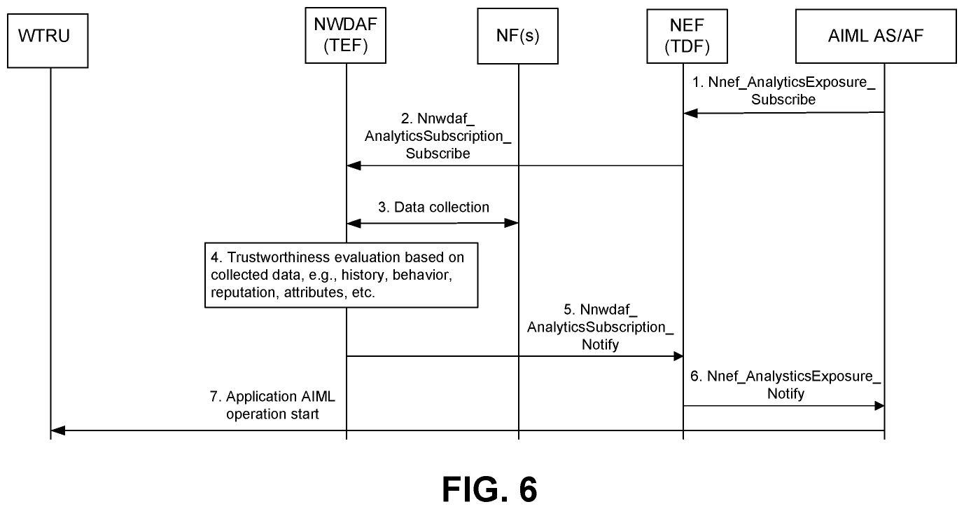

FIGS. 4-6 illustrate additional examples of operations, messages, and/or call flows associated with a trustworthiness evaluation that may occur in a wireless communication system (e.g., a 3GPP system). It should be noted that although some information is depicted in the figures as being carried inside a specific message (e.g., Nnef_AnalyticsExposure_Subscribe, Nnef_AnalyticsExposure_Notify, etc.), those skilled in the art will understand that the information may also be carried in other types of messages. Using FIG. 6 as an example, one or more WTRUs may be selected for an AIML operation based on the trustworthiness of the WTRUs. At 1, an AIML AF (or AS) may select a set of candidates (e.g., WTRUs) for which trustworthiness analytics reporting (e.g., by a network device, entity, or function such as an NWDAF) is desired. The set of candidates may include, e.g., a WTRU or a group of WTRUs, and the AIML AF may select these candidates based on, for example, the characteristics of the traffic associated with the AIML operation to be executed. The AIML AF may provide the candidate set to a network device, entity, or function (e.g., such as the NEF) that may be configured to host a trust determination function (TDF). The AIML AF may indicate a set of selection criteria to the TDF, and the TDF may screen WTRUs based on the selection criteria provided by the AIML AF. For example, the AIML AF may send a request to the NEF (TDF), and the request may include a candidate list of WTRUs for screening. As another example, the AIML AF may send a request to the TDF and the request may include a set of criteria that the TDF may use to create a list of WTRUs for screening. The criteria may indicate that an application server may desire a list of WTRUs (e.g., 100 WTRUs) located in a geographical area, a list of WTRUs that may use resources from a particular network slice, a list of WTRUs that may be associated with certain traffic characteristics (e.g., certain latency thresholds, certain bit error rates, certain QoS requirements, etc.), and/or the like. The NEF (TDF) may query another network function such as a UDM or a UDR to obtain a list of candidates that may include one or more WTRUs matching the indicated criteria. The NEF (TDF) may map the request from the AIML AF onto a set of analytic IDs and/or analytics filters (e.g., as described herein) and may use the mapping to derive specific trustworthiness analytics for the analytics reporting targets included in the list of candidates (e.g., WTRUs).

At 2 (e.g., after a candidate set is produced by the NEF (TDF)), the NEF (TDF) may send a trustworthiness evaluation request (e.g., the request from the AIML AF) to another network device, entity, or function such as an NWDAF, which may host a trust evaluation functionality (TEF). In response to receiving the request, the NWDAF (TEF) may, at 3, obtain WTRU trustworthiness data (e.g., according to the analytics filters and/or analytics IDs provided by the AIML AF) from other network devices or network functions (NFs) and/or WTRUs, and may use the data to generate analytics for evaluating the trustworthiness of a WTRU as a candidate for supporting the AIML operation (e.g., an FL operation). As described herein, the collected data may include but may not be limited to the WTRU's history as an AIML client, expected behaviors of and/or feedback regarding the WTRU as an AIML operation client in the past, referrals from other AIML application servers for the WTRU, the WTRU's reputation when collaborating with other WTRUs and/or AIML application servers, the WTRU's security posture such as security software patches installed on the WTRU, trusted environment capabilities, logs on the WTRU, privileges of the WTRU, a network security state, security policy rules, subject attributes, etc. The trustworthiness analytics determined by the NWDAF based on the collected data may be deemed valid within a validity time window that may be provided/indicated by the NWDAF.

At 4, the NWDAF (TEF) may evaluate the trustworthiness of a (e.g., each) WTRU in the candidate set using the data collected from the relevant NFs. The evaluation may be conducted using the techniques described herein. The trustworthiness level of the WTRU (or a group of WTRUs), which may be associated with certain network resources (e.g., S-NSSAI, DNN, and/or AF), may be determined by the NWDAF (TEF) and provided to the AIML AF (e.g., directly) or to another network device, entity or function such as the NEF (TDF) (e.g., as an analytics consumer or relay). The NWDAF (TEF) may use AIML algorithms to perform the trustworthiness evaluation based on the data collected at 3. These algorithms may include, e.g., clustering, neural networks, fuzz logics, rule-based algorithms, and etc. The NWDAF (TEF) may use a combination of these algorithms to produce a trustworthiness score (e.g., with flexibility to accommodate a specific situation).

The evaluation criteria used by the NWDAF (TEF) may be broadened to factor other attributes or operational aspects of a WTRU into the evaluation. For example, the selection may be performed based on a WTRU's capabilities to accurately and reliably execute the AIML operation, and the NWDAF (TEF) may consider a WTRU suitable for the AIML operation if the WTRU has the ability to provide data that accurately represent a user's experience.

At 5, the NWDAF (TEF) may provide the trustworthiness level or score of the WTRU(s) (e.g., of each WTRU) in the candidate set to another entity such as the NEF (TDF) (e.g., in a Nnwdaf_AnalyticsSubscription_Notify message). The NEF (TDF) may screen the received trustworthiness level(s) or score(s) (e.g., based on resource access policies), for example, if the NEF (TDF) is configured or enabled by an operator to further screen the WTRUs based on their trustworthiness levels or scores. If the NEF (TDF) is configured or enabled (e.g., by choice of the operator) to do so, the NEF (TDF) may (e.g., dynamically) determine whether a WTRU (e.g., reported by the NWDAF (TEF) is trustworthy based on a trustworthiness score that the NEF (TDF) may construct for the WTRU as a function of one or more factors such as, e.g., resources accessed by the WTRU, traffic type(s) associated with the WTRU (e.g., traffic generated by a specific application AIML operation type such as federated learning), a least privileged principle, etc.

At 6, the NEF (TDF) may (e.g., upon applying one or more resource access policies) send (e.g., in an Nnef_AnalyticsExposure_Notify message) a screened set of candidates (e.g., WTRUs) to be used by the AIML AF. For example, the NEF (TDF) may provide the trustworthiness levels or scores of one or more candidate WTRUs to the AIML AF, which may make a decision as to which WTRU(s) may participate in the AIML operation.

At 7, the AIML AF may carry out the relevant AIML operation (e.g., if the AIML AF agrees with the WTRU selection decision from the NEF (TDF). For example, the AIML AF may start a next round of FL operations by sending an intermediate model to the selected WTRUs. In examples, the AIML AF may, based on the trustworthiness level of a WTRU, provide the WTRU with a trustworthiness token. In examples, the trustworthiness token may be generated for (e.g., digitally signed) and/or provided to the WTRU and/or the AIML AF by another network entity such as the NWDAF (TEF) that may have the authority to evaluate the trustworthiness of the WTRU. The trustworthiness token may be valid for the duration of an analytics validity time (e.g., which may be provided by the NWDAF (TEF)). During such a validity time, the WTRU may use the token when engaging in application AIML operations with the AIML AF.

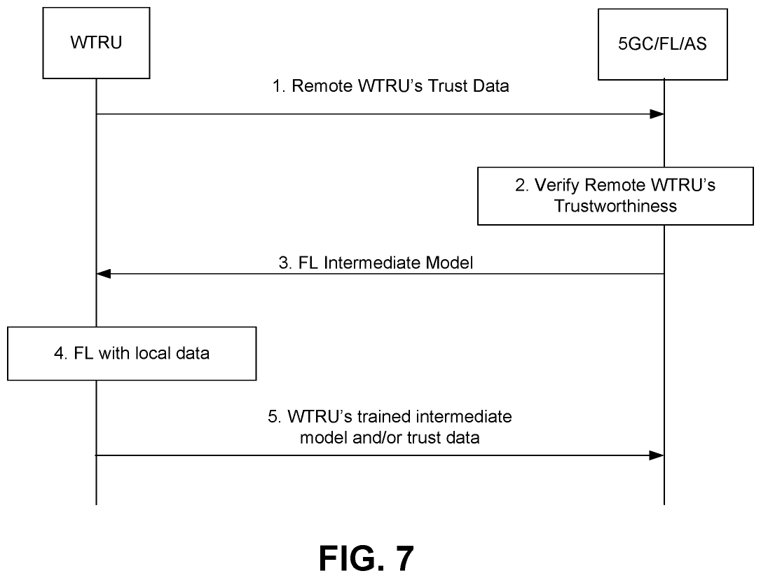

The trustworthiness of a WTRU may be evaluated during PDU session establishment. FIG. 7 illustrates an example of exchanging trust information between a WTRU and a core network, such as a 5GC within a PDU session establishment context. As shown, the WTRU may provide (e.g., within PDU session establishment context and/or capabilities) an indication that the WTRU supports AIML related trustworthiness reporting. A network function such as the SMF may use subscription data (e.g., as a part of the session management subscription data used for PDU session establishment) to determine whether the WTRU is subject to a trustworthiness evaluation. If the WTRU is subject to the trustworthiness evaluation, WTRU trust data as described herein may be sent, for example, during PDU session establishment, by an AIML agent (e.g., on the WTRU). The trust data may be sent in an NAS message (e.g., within a transparent container of the NAS message) as a part of an event notification. For example, the trust data may be sent a NAS message packet and the data may not be understood by one or more intermediate nodes. This may be similar to the operation executed for secondary authentication of an external data network in that a core network function such as the SMF may forward the trust data provided by the WTRU to an AIML AS so that the data may be forwarded to an NWDAF via an service-based interface (SBI) or an NEF.

AIML operations may be associated with a particular data network name (DNN) and/or single network slice selection assistance information (S-NSSAI) (e.g., with FL specific quality of service (QoS) and/or charging requirements). PDU session resources may be allocated on the condition that an AIML AS may grant an authorization for a WTRU to participate in a specific AI/ML operation based on a trustworthiness assessment of the WTRU (e.g., as described above). As shown in FIG. 7, FL information (e.g., an intermediate FL model) may be indicated at 3, for example, in a transparent container of a successful PDU session setup message (e.g., a PDU session accept/modify message).

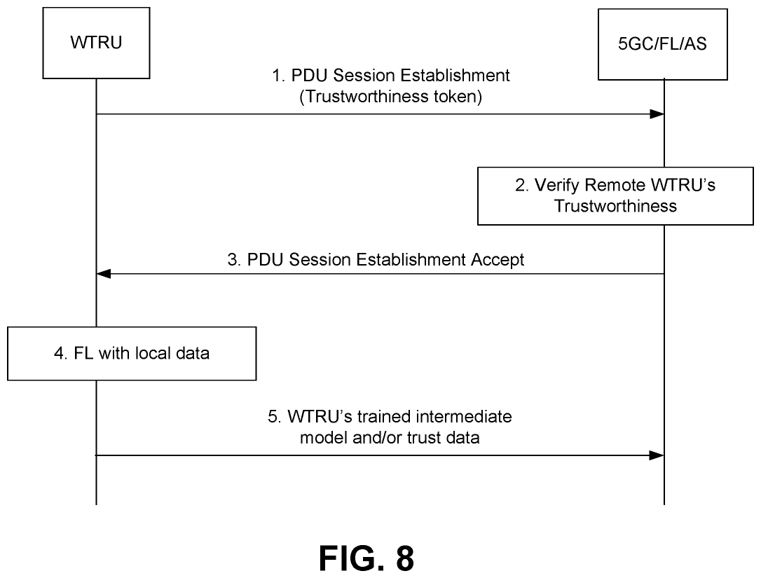

FIG. 8 illustrates another example of trustworthiness information exchange between a WTRU and a network device such as a core network device during PDU session establishment. At 1, the WTRU may provide (e.g., in a PDU session establishment request) the network device with a trustworthiness token that may be obtained during (e.g., at the start of) an application AIML operation as described herein. The presence of the token may be taken by a session management function (SMF) as an indication that the WTRU possesses capabilities to support AIML trustworthiness functionalities. The trustworthiness token may be used (e.g., along with subscription data such as session management subscription data used for the PDU session establishment) by the SMF to determine whether the WTRU is subject to trustworthiness evaluation (e.g., on the DNN that may be indicated by the WTRU in the PDU session establishment request).

In examples, the trustworthiness token may also be provided by an AIML agent. For example, the token may be provided within a transparent container in an NAS messages. This may be similar to operations executed for secondary authentication of external data networks during which a core NF such as an SMF may forward the trustworthiness data provided by WTRU to an AI/ML AF via NEF (e.g., as part of an event notification).

At 2, the SMF may verify the trustworthiness level of the WTRU sending the PDU session establishment request, for example, using the trustworthiness token provided at 1. The SMF may determine that traffic requirements (e.g., QoS requirements and/or latency requirements) for resources associated with a specific application AIML operation may be associated with a particular DNN or S-NSSAI (e.g., with FL specific QoS or charging requirements). PDU session resources may be allocated on the condition that an AIML AF may grant authorization for the WTRU to participate in the specific AIML operation based on the trustworthiness assessment described herein.

At 3, a successful verification of the trustworthiness level of the WTRU may be provided (e.g., to the WTRU) in a PDU session establishment accept message (e.g., via a transparent container), for example, if resources are granted to support the required QoS for a particular traffic.

At 4, the WTRU may use the result of the trustworthiness assessment to trigger the start of an application AIML operation such as federated learning (e.g., using local data).

At 5, the WTRU may send a trained intermediate model, e.g., along with trust data (e.g., the trustworthiness token described herein) to the AIML AF, and the AIML AF may use this information to assess the trustworthiness level of the trained intermediate model sent by the WTRU.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed is:

1. A network entity, comprising:
a processor configured to:
receive a request to evaluate a trustworthiness of a wireless transmit/receive unit (WTRU) for participating in one or more operations of a wireless communication network, wherein the request includes a set of criteria associated with the evaluation;
collect information regarding the WTRU based on the set of criteria indicated by the request;
determine, based on the collected information, the trustworthiness of the WTRU for participating in the one or more operations of the wireless communication network; and
send an indication of the trustworthiness of the WTRU for participating in the one or more operations of the wireless communication network.

2. The network entity of claim 1, wherein the one or more operations of the wireless communication network include an artificial intelligence machine learning (AIML) operation.

3. The network entity of claim 2, wherein the AIML operation is associated with training an AIML model.

4. The network entity of claim 1, wherein the set of criteria included in the request indicates at least one of a geographical location, a network slice, a data network name, or an application associated with the one or more operations of the wireless communication network.

5. The network entity of claim 1, wherein the set of criteria indicates at least one of a time period associated with the evaluation, an artificial intelligence machine learning model associated with the one or more operations of the wireless communication network, a traffic characteristic of the one or more operations of the wireless communication network, or an application server associated with the one or more operations of the wireless communication network.

6. The network entity of claim 5, wherein the traffic characteristic of the one or more operations of the wireless communication network includes at least one of a latency threshold, an error rate, or a quality of service requirement.

7. The network entity of claim 1, wherein the information collected by the network entity indicates at least one of a privilege or security state of the WTRU, or a behavior history of the WTRU.

8. The network entity of claim 1, wherein the information collected by the network entity indicates at least one of an attribute or reputation of the WTRU, a referral for the WTRU to participate in the one or more operations of the wireless communication network, or a security policy of the wireless communication network.

9. The network entity of claim 1, wherein the indication of the trustworthiness of the WTRU includes a trustworthiness level of the WTRU, an identifier of the WTRU, or a time period during which the indication is deemed valid.

10. The network entity of claim 1, wherein the request to evaluate the trustworthiness of the WTRU is received from another network entity or an application server, and wherein the indication of the trustworthiness of the WTRU is sent to the other network entity or the application server.

11. The network entity of claim 1, wherein the processor is further configured to generate a token for the WTRU that indicates the trustworthiness of the WTRU for participating in the one or more operations of the wireless communication network.

12. A method implemented by a network entity, the method comprising:
receiving a request to evaluate a trustworthiness of a wireless transmit/receive unit (WTRU) for participating in one or more operations of a wireless communication network, wherein the request includes a set of criteria associated with the evaluation;
collecting information regarding the WTRU based on the set of criteria indicated by the request;
determining, based on the collected information, the trustworthiness of the WTRU for participating in the one or more operations of the wireless communication network; and
sending an indication of the trustworthiness of the WTRU for participating in the one or more operations of the wireless communication network.

13. The method of claim 12, wherein the one or more operations of the wireless communication network include an artificial intelligence machine learning (AIML) operation.

14. The method of claim 13, wherein the AIML operation is associated with training an AIML model.

15. The method of claim 12, wherein the set of criteria included in the request indicates at least one of a geographical location, a network slice, a data network name, or an application associated with the one or more operations of the wireless communication network.

16. The method of claim 12, wherein the set of criteria indicates at least one of a time period associated with the evaluation, an artificial intelligence machine learning model associated with the one or more operations of the wireless communication network, a traffic characteristic of the one or more operations of the wireless communication network, or an application server associated with the one or more operations of the wireless communication network.

17. The method of claim 16, wherein the traffic characteristic of the one or more operations of the wireless communication network includes a latency threshold, an error rate, or a quality of service requirement.

18. The method of claim 12, wherein the information collected by the network entity indicates at least one of a privilege or security state of the WTRU, a behavior history of the WTRU, an attribute or reputation of the WTRU, a referral for the WTRU to participate in the one or more operations of the wireless communication network, or a security policy of the wireless communication network.

19. The method of claim 12, wherein the indication of the trustworthiness of the WTRU includes a trustworthiness level of the WTRU, an identifier of the WTRU, or a time period during which the indication is deemed valid.

20. The method of claim 12, wherein the request to evaluate the trustworthiness of the WTRU is received from another network entity or an application server, and wherein the indication of the trustworthiness of the WTRU is sent to the other network entity or the application server.

21. A wireless transmit/receive unit (WTRU), comprising:
a processor configured to:
collect information about the WTRU, wherein the information is associated with at least one of a security state of the WTRU, a behavior history of the WTRU, or an attribute of the WTRU;
send the collected information to a server device associated with a wireless communication network;
receive an indication of a trustworthiness of the WTRU for participating in one or more operations of the wireless communication network, wherein the trustworthiness of the WTRU is determined based at least on the information collected and sent by the WTRU; and
participate in the one or more operations of the wireless communication network based on the indication of the trustworthiness of the WTRU.
